(19) United States
(12) Patent Application Publication
(10) Pub. No.: US 2010/0023436 A1
(43) Pub. Date: Jan. 28, 2010

(54) PERPETUAL REVENUE PARTICIPATION INTERESTS AND METHODS RELATED THERETO

(76) Inventor: David Weild, IV, Bronxville, NY (US)

Correspondence Address: Nelson Mullins Riley & Scarborough LLP;IP Department, 100 North Tryon Street, 42nd Floor, Charlotte, NC, 28202-4000, US

(21) Appl. No.: 12/507,433

(22) Filed: Jul. 22, 2009

Related U.S. Application Data
(60) Provisional application No. 61/135,636, filed on Jul. 22, 2008.

(51) Int. Cl. G06Q 40/00

(52) U.S. Cl. 705/35

(57) ABSTRACT

A financial product and method for creating a financial product is provided wherein an investor receives a return based on the future sales or revenues of an issuer in perpetuity.

### BACKGROUND OF THE INVENTION

(1) Field of the Invention

The present application claims priority to U.S. patent application Ser. No. 61/135,636, filed Jul. 22, 2008, which is incorporated herein by reference thereto in its entirety.

The present invention relates generally to financial products concerning and methods for implementing a revenue participation interest to provide investors with payments based on an issuer's revenue stream.

(2) Description of the Related Art

Revenue participation interests have historically taken the form of franchise agreements (e.g., establishment of restaurants), royalty payments in exchange for a license to intellectual property (e.g., a patent license), and, recently the issuance of a finite-term security by an issuer to investors in exchange for consideration such as cash. The latter example has been deemed a “Sales Participation Certificate” by its inventor, Henry Schulman and is described in detail in U.S. Pat. No. 7,149,719 and in U.S. patent applications Ser. No. 10/153,052 (published as US 2003/0204459) and Ser. No. 11/057,552 (published as US 2005/0222940), all three of which are incorporated herein in their entireties by reference thereto and which are collectively referred to as Schulman herein.

To date, the various permutations of revenue participation interests embodied in Sales Participation Certificates have been of relatively short (12 years or shorter) finite life terms or are established with a claim against a finite pool of assets. These structures, as conceived, are meant to be secured or unsecured debt instruments such that a component of the cash payments to investors will likely be treated as repayment of principal while the remainder, which constitutes the investor's return component, would likely be treated as interest income, which may allow the issuing company to take a deduction for payments made to thereby reduce its tax liability.

The financial products created by Schulman provide a return that is a function of future sales/revenues, preferably gross sales/revenues, over a specified period of time. As opposed to asset-backed securities, securitization of such a function represents a property interest in the stream of payments from an organization's sales or other revenues. Typically, but not always, no assets segregated as collateral for this security. The terms to the issuer include providing capital to the issuer in exchange for a return to the investor that is a function of future sales of the issuer over a specified period of time.

### SUMMARY OF THE INVENTION

Briefly, therefore, the present invention is a financial product that provides investors with payments based on an issuer's revenue or sales stream where the term of the product is perpetual, i.e., not limited by a specified time period. This type of product is referred to herein as a “Perpetual Revenue Participation Interest.”

In other embodiments, the present invention is a method that provides investors with payments based on an issuer's revenue or sales stream where the term of the product is perpetual, i.e., not limited by a specified time period.

### BRIEF DESCRIPTION OF THE DRAWINGS

These and other features, aspects, and advantages of the present invention are better understood when the following Detailed Description is read with reference to the accompanying drawings, wherein:

FIG. 1A is a bar chart illustrating the decline in small initial public offerings (“IPOs”) in the U.S. since 2001;

FIG. 1B is a bar chart illustrating the number of IPOs prior to 1999;

FIG. 2 is a chart illustrating the fixed costs of going public during 1999-2007;

FIG. 3 is a chart illustrating the range of outcomes for IPOs during 2005-2007;

FIG. 4A1 is a chart illustrating the financing cost of a 10-year fixed term versus perpetual instrument;

FIG. 4A2 is another chart illustrating the financing cost of a 10-year fixed term versus perpetual instrument;

FIG. 4B1 is another chart illustrating the financing cost of a 10-year fixed term versus perpetual instrument; and

FIG. 4B2 is another chart illustrating the financing cost of a 10-year fixed term versus perpetual instrument.

### DETAILED DESCRIPTION OF THE PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

The present financial products provide investors with payments of cash or other returns based on an issuer's revenue or sales stream where the term of the product is essentially perpetual, i.e., not limited by a specified time period. As used herein, the terms “perpetuity” and “perpetual” mean for the time period during which the issuing company is generating sales or receiving revenue for conducting its business (i.e., the period of the life of the company). The Perpetual Revenue Participation Interest may be structured to function in many ways more like a cash-pay equity instrument, as opposed to a debt instrument.

One embodiment of a method according to the invention includes providing forms to an issuer and to an underwriter and terms to an issuer and to investors. The terms to the issuer include providing capital to the issuer in exchange for a return that is a function of future gross sales/revenues over the life of the issuing company (i.e., in perpetuity). The method further includes determining from the issuer, e.g., from the forms, the amount of capital desired and calculating an appropriate function, e.g., percentage, of sales to achieve the desired capital contribution to the issuer.

Based on an appropriate function, e.g., percentage, of sales, the method creates instruments in sufficient numbers and appropriate denominations to facilitate trading in the underlying financial product. One embodiment of a method according to the invention, given a proposed issue amount, divides the issue amount by a fixed denomination to determine the number of instruments. The fixed denomination is such that the instruments are tradable securities given the then current market conditions. In other words, one can set the value of the fixed denomination to reflect the denominations of other existing securities, e.g., other similar securities, in the market. For example, if the issue amount is 1 million dollars and the fixed denomination is 100 dollars then the number of instruments is 10,000. Approximately concurrent with, and in one embodiment prior to, the creation of instruments, the method may include obtaining opinion of counsel, based on the terms (which may be standard terms and which may or may not be negotiated/negotiable) and completed forms, hiring a registrar to keep the books, and hiring a trustee to collect and distribute revenues owed. Finally, the method includes conducting a public or private offering of the security instruments created.

Thus, one embodiment of a method according to the invention securitizes a portion of the proceeds of future gross sales/revenues, an item that is easily audited, turning it into property that can be traded in a secondary market on an exchange, should an exchange arrange to trade in these securities, or over-the-counter (OTC). An OTC security is a security that is not traded on an exchange, usually due to an inability to meet listing requirements. For such securities, broker/dealers negotiate directly with one another and/or investor(s) over computer networks and by phone.

One embodiment of a method according to the invention includes creating a financial product by providing forms and terms between the issuer and the trustee who is the fiduciary representing the interests of the investor, and between the issuer and the underwriter who is to be paid for underwriting the issue. Typically, issuers sell and investors buy and trade in securities with the help of market intermediaries. In the primary market, underwriters distribute securities from issuers to investors. In other words, an issuer provides the issuer's obligation to the underwriter in exchange for a commitment of capital. The underwriter in turn provides the issuer's obligation to investors in exchange for money. As noted above, the terms of the issuer's obligations, when issuing this security, include providing a return that is a function of future sales/revenues in perpetuity. The trustee then collects and distributes revenues owed pursuant to the issuer's obligations outlined in the forms and terms. In the secondary market, a broker/dealer trades securities for money with investors. Thus, a generic investor can sell sales certificate(s) to a broker/dealer for money and another generic investor can purchase sales certificate(s) from the broker/dealer for money. The broker/dealer typically prefers to end each trading day with no inventory, i.e., with longs equal to shorts. In addition, if available, the broker dealer can trade as agent for investors on an exchange.

The entire process, or portions of the process, can be handled by computer systems. For example, the creation of the instruments representing the security, the transacting for the returns to the investors, the tracking and calculation of payouts based on issuer's sales, and the receipt and distribution of capital from the investors can all be handled jointly or separately by a computer system.

Such instrument representing securities based on future sales/revenues in perpetuity may have a number of advantages including: 1) allowing companies to finance themselves in conditions when markets would be less receptive to an equity offering or traditional debt issue or revenue participation interest having a specified, defined life term by offering investors an instrument that offers the potential for growth and current income; 2) obviating the need in private company financings for a “liquidity put” where investors demand a sale of the company, repurchase of the instrument or return of principal; and 3) ultimately, possibly facilitating the development of a new mezzanine market that would bridge later-staged venture- and private equity-funded companies to an IPO.

The major advantage of the perpetual revenue participation versus traditional finite life or fixed-asset pool revenue participation interests such as Schulman is that the perpetual structure eliminates the issuer's obligation to pay back principal, thereby significantly decreasing the amount of cash the company must pay out, especially in the early years of the instrument, to fund the security. Thus, the cash burden on the issuing company will be significantly less than that of an analogous finite life revenue participation interest.

While the possibility exists that the Perpetual Revenue Participation Interest would likely be treated as a dividend and, thus, may be tax inefficient, the product may still be advantageous to investors and issuers for various reasons. In addition, the structure, without certain features, as described below, may have a cost that might make it an uncompetitive (relative to traditional debt or revenue participation interests of fixed maturities) and, thus, non-viable form of finance if traditional debt and equity markets are functioning in a normal efficient manner.

However, for certain types of companies that are not tax-payers and for others that anticipate becoming a tax-payer at a future date, where the inclusion of certain redemption and/or exchange features will allow the elimination of adverse tax consequences, the Perpetual Revenue Participation Interest will likely compare very favorably to other forms of equity and or debt finance and may be the only viable option to many small companies seeking capital.

The structural and regulatory changes to the capital markets over the last decade (notably the internet, decimalization and, in the United States, Sarbanes-Oxley) have undermined the support infrastructure of commission-based retail brokerage and market makers willing to commit capital for smaller-sized equity financings, including IPOs. The introduction of the novel Perpetual Revenue Participation Interest which, unlike traditional debt, offers growth and current cash payout to lower the instrument's volatility relative to equity and provides market makers with a positive cash return on their investments, may help to reopen the market for many smaller companies. In addition, this type of instrument may find application to many larger corporations that have large variable costs which result in difficulty hedging over the long-term (e.g., metals and mining; energy exploration and production, information technology outsourcing and business process outsourcing).

Such novel “perpetual” revenue participation interests have not been issued as financing instruments to raise primary or secondary capital as security interests in a fixed percentage of an issuing company's revenues (as distinct from a royalty interest in an oil well, a pharmaceutical product, a film or an otherwise finite pool of assets). Such Perpetual Revenue Participation Interests issued by operating companies against their top-line GAAP revenue has heretofore been unrecognized and not attempted because of the likely tax inefficiency of the instrument when applied to the typical corporation. This inefficiently is perceived as fatal to the general usefulness by taxpaying companies of the instrument, especially when equity issuance is a viable alternative.

The potential tax inefficiency of this instrument can be handled in a number of ways, including redemption or exchange features that allow the company to retire the instrument at the point at which the issuer becomes a taxpayer and the cost of the instrument is deemed to be too high relative to traditional equity or debt alternatives. In addition, many private companies may have accrued losses and, as a consequence, the net operating loss carry-forwards allow them not to have an adverse tax consequence in meeting the cash payment needs of these securities. Finally, there are certain flow-through structures, including LLCs, LPs, REITs, RICs, S-Corps and non-profits (e.g. charities) where there is no taxation at the level of the corpus to worry about. Such structures are not taxpayers and generally incur heavy losses and have a large net operating loss to “carry forward” and shelter any earned income for some period of time or window. In these instances, the cost to the issuer of issuing a Perpetual Revenue Participation Interest will be acceptable until such a time as the company becomes a taxpayer again (i.e., has used up its net operating loss. At the point that the issuer becomes a taxpayer, there must be features that allow the issue to exchange the instruments for a tax efficient structure (e.g., non-Perpetual Revenue Participation Interests, traditional debt securities, common stock or some other instrument) or to redeem the securities outright by some process, which could include a company call option and redemption schedule or a tender offer. Alternatively, the issuer could tender to redeem the instrument—much like an issuer could tender for common stock or bonds.

“Perpetual Revenue Participation Interests” may have the following features:

1) The “Perpetual Revenue Participation Interest” would represent a perpetual interest in a company's revenues (including, but not limited to, the full range of corporate structures such as C-Corp, S-Corp, REIT, RIC, LLC, LP, etc.)

2) Pricing of the Perpetual Revenue Participation Interest may or may not be negotiated.

3) Perpetual Revenue Participation Interests may or may not have dividends declared.

4) Perpetual Revenue Participation Interests may or may not have an “ex-distribution” date that determines whether the purchaser of the instrument is entitled to the most recent declared distribution.

5) Perpetual Revenue Participation Interests may or may not include a distribution true-up (also known as a “make whole”) provision wherein if a subsequent discovery of a discrepancy (whether by audit or some other mechanism) in GAAP revenues determines that the beneficial owners were entitled to larger distribution, the holders of record on the original distribution date would be made whole and this incremental payment may or may not include interest and/or penalties.

6) Perpetual Revenue Participation Interests may or may not be traded.

7) Perpetual Revenue Participation Interests from a particular issue or issuer may be held by one or more investors.

8) Perpetual Revenue Participation Interests may be issued in the private market or as publicly registered instruments.

9) Perpetual Revenue Participation Interests may or may not be offered by standard term sheets.

10) Perpetual Revenue Participation Interests may or may not have been negotiated (subject to negotiated terms)

11) Perpetual Revenue Participation Interests may or may not be denominated in increments and prices that facilitate trading.

12) Perpetual Revenue Participation Interests may or may not include an issuer-held redemption feature.

13) Perpetual Revenue Participation Interests may or may not have “hard call protection” for a defined period of time, meaning that the revenue participation interest cannot be redeemed or exchanged for some period of time (e.g., 3 years from the date of issuance).

14) Perpetual Revenue Participation Interests may or may not have “soft call protection” meaning that the Perpetual Revenue Participation Interest must be trading at some premium to issue price (e.g., 30 days) for a minimum number of days before it can be called or exchanged.

15) Perpetual Revenue Participation Interests may or may not include an investor-held mandatory or optional redemption (“put”) features that may or may not be activated by an event such as the sale of the company.

16) Perpetual Revenue Participation Interests may or may not have a mandatory redemption or exchange feature such as, in the event that the issuer defaults on any indebtedness, the Perpetual Revenue Participation Interests are automatically exchanged for the debt or other securities of the issuer.

17) Perpetual Revenue Participation Interests may or may not include an issuer-held exchange option feature:

a. Where the Perpetual Revenue Participation Interest may be exchanged for a non-Perpetual Revenue Participation Interest of similar terms but finite life (say 25 years) but with otherwise similar economic (to the holder) terms.

b. Where the Perpetual Revenue Participation Interest is exchangeable for a third security (such as common stock) at the option of the issuer or in the event of an event trigger, such as an IPO on some pre-specified or formula that defines the rate at which the exchange would take place.

c. Where a similar value of one of the issuers securities may be exchanged for all shares of a Perpetual Revenue Participation Interest, then outstanding. So, for example, if the common stock of the company was traded and the Perpetual Revenue Participation Interests were also traded, the latter may be exchanged for common stock, for example, based on the value a value set for the Perpetual Revenue Participation Interests that is the higher of the then current price, when announced or the average of the last 30 calendar days of trading prices on the close of market. The value of the common stock used for this exchange might be at the lower of the then-current price of the common stock or the average of the last 30 calendar days of trading prices on the close.

d. Alternatively, the issuer could tender cash or securities for the Perpetual Revenue Participation Interests then outstanding.

18) Perpetual Revenue Participation Interests may or may not include an investor held conversion feature (e.g. where the Perpetual Revenue Participation Interest is convertible into a fixed, or variable by some formula, number of shares of common stock or some other security of the company).

19) Perpetual Revenue Participation Interests may or may not have an embedded (or strippable) investor-held “put” option that requires the issuer to repurchase the instrument on a certain date(s) at a specified price(s) (including a price specified by formula).

20) Perpetual Revenue Participation Interests may or may not be current cash pay, accrued but not cash pay, or partial cash pay instruments.

The market for sub-$75 million IPOs is experiencing a long-term secular decline. Structural and regulatory change has eroded support for smaller IPOs. When small IPOs become a less viable financing alternative, it diminishes the attractiveness of investing in private companies in general since the IPO market is a less reliable mechanism to create the liquidity that private investors rely upon to realize investment returns. Perpetual Revenue Participation Interests may help solve this challenge, at least for companies with revenues, or the prospect of near-term revenues, because the security should be inherently more liquid. Current cash payout leads to lower volatility, positive “cost to carry” positions, and a focus on GAAP revenue rather than reported earnings that may make it more transparent.

Recently, the National Venture Capital Association announced that the second calendar quarter of 2008 was the first quarter since 1978 where no venture-capital funded company was able to go public in the United States. The poor performance of the initial public offering market will, in turn, undermine equity valuations in the private market. Professional investors rely on the public markets to realize the value of their private company investments and limit the interest (i.e., availability of equity capital) in making equity investments. As a result of these dynamics, a novel security option such as Perpetual Revenue Participation Interests that can provide investors with greater liquidity (the instruments will have lower volatility because of the cash return component plus market makers and other investors will be more willing to commit capital in the aftermarket because, unlike equity, the cash return component will compensate them for their cost of capital), a direct cash-on-cash return, and equity-like growth (through direct participation in the revenue growth of the company). For issuers, the advantage over the traditional finite-term participation certificates would be that the security (Perpetual or Long-Dated) minimizes the current cash payment burden on the corporation by eliminating (Perpetual) or minimizing (Long-Dated Maturities) the annual repayment of principal to investors.

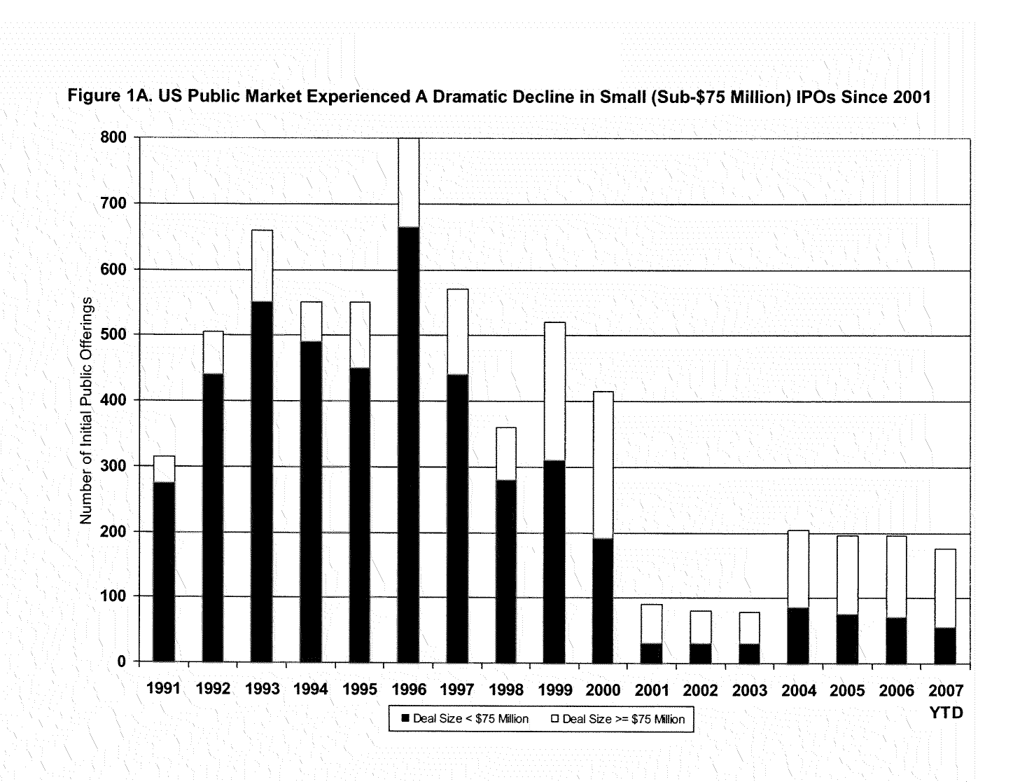

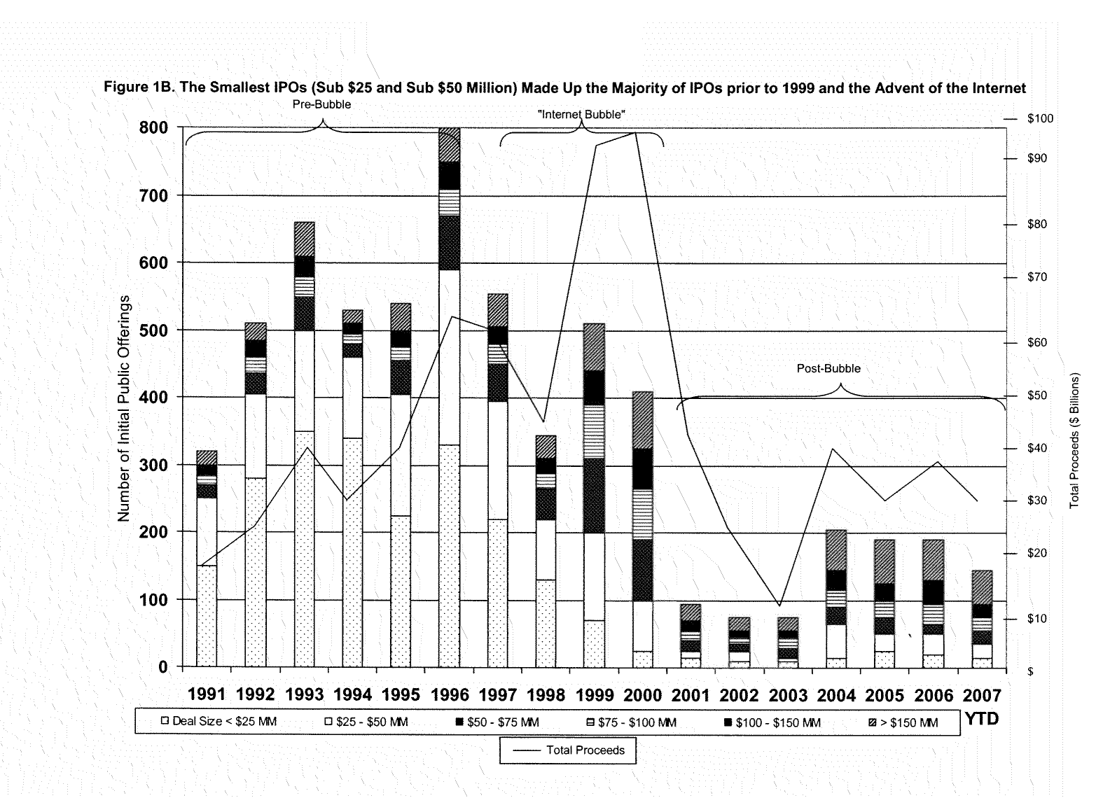

Those structural and regulatory changes have put pressure on traditional forms of equity finance, especially for small capitalization and pre-IPO companies, and the recent debt crisis has made it difficult for companies to also obtain loans. The effects of this pressure can be seen through the data in FIGS. 1 and 1B where the number of smaller IPOs (sub $25 million, sub $50 million and sub $75 million), which historically represented the majority of IPOs in the United States and the majority of venture capital “exits”, has largely disappeared.

The viability of public equity offerings has been in a long-term secular decline beginning in 2001. As shown in FIG. 1, the number of sub-$75 million IPOs is a fraction of what it was in the pre-“Internet Bubble” period of 1991-1996 and the “Bubble” period from 1997-2001).

The smallest sized IPOs—Sub $25 million IPOs—once made up the majority of IPOs. As shown in FIG. 1B, this segment has all but disappeared from the market.

If revenue participation interests prove viable, it might open the door to many smaller financings that the IPO market is not currently able to facilitate. A $25 million offering is already large for the venture capital industry. Thus, Perpetual Revenue Participation Interests may fill an important gap and help bridge companies to a size where they can realistically undertake a traditional IPO.

Since there are many more small companies than large companies (the distribution by size of companies is said to be logarithmic meaning that there are as many companies in the $1-10 million revenue range as there are in the $10-100 million revenue range as there are in the $100-$1 billion revenue range, etc.), the ability to finance small companies is typically seen as a “bridge” to these companies becoming larger companies. Thus, the market erosion of forms of finance for smaller companies, including the IPO market, may have profoundly negative implications for long-term economic growth. Thus, the emergence of a new form of financing that addresses this problem may have profound benefits to issuers and the venture capital and private equity business which, in turn, will benefit economic growth and competitiveness.

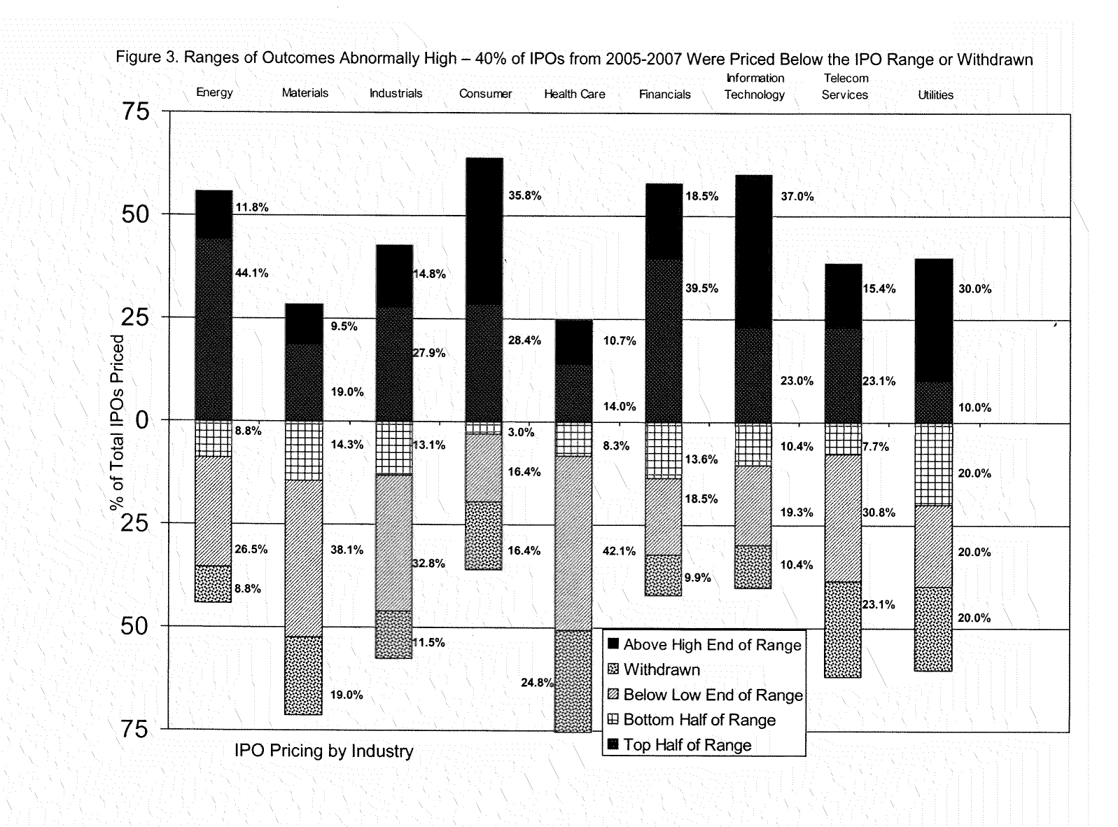

Factors that have made it more time intensive, more costly, more difficult, and more risky (see FIG. 3 where 40% of IPOs from 2005 to 2007 were priced below the low-end of the IPO indicative price range or withdrawn) to undertake an IPO, particularly a small IPO, include:

a. The Internet—The internet triggered price competition in retail brokerage commissions by ushering in an age of direct execution only brokerage firms such as E*Trade and Ameritrade, causing the full-service broker dealer to migrate from a transaction-based pricing model that encourage traditional stock brokerage to one that is asset-based and encourages the accumulation of assets. As a result, smaller IPOs and small public companies in general, which traditionally found sales and marketing support from the retail brokerage community, no longer enjoy this so-called “sponsorship” to the same degree.

b. Decimalization—When the SEC mandated decimals in 2001, 96% of trading spread (the difference between the quoted “bid” and the “ask” price for a common stock) economics were lost from many trades where stocks, especially small cap stocks, traded in ¼ point ($0.25 cent) spreads (the difference between the quoted “bid” and “ask”) and suddenly began trading in 1 cent increments. This created an environment where it was no longer economical for market makers to commit capital and where the order flow generated by equity research analysts that might cover the stock was also less economically viable. As a result, the minimum deal size (as measured in gross proceeds raised) for an economically viable (to Wall Street) transaction was raised. See FIGS. 1 and 1B, which depict the number of IPOs above and below $75 million in size. Beginning in 2001, the year when decimals were implemented at NASDAQ and the NYSE, the number of sub $75 million IPOs declined dramatically and has failed to rebound to its pre-“Internet Bubble” levels as seen in the period of 1991-1996. Much of the support for small cap stocks and smaller IPOs evaporated.

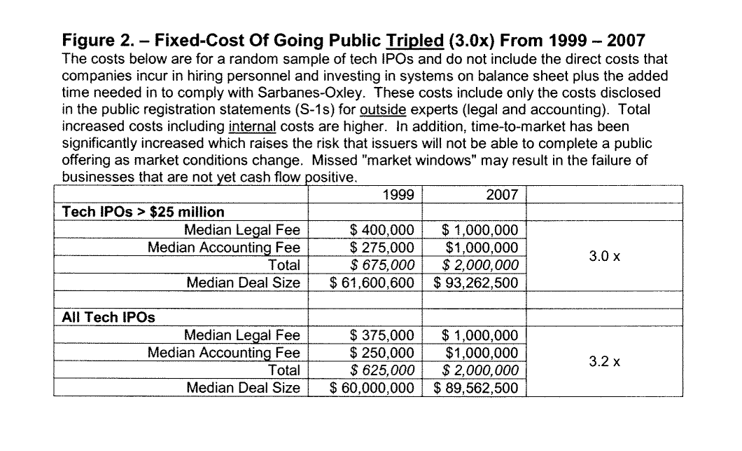

c. The Sarbanes-Oxley Act—The time, risk, and costs to issuers to go public escalated dramatically as a result of the Sarbanes-Oxley Act, which was a response to a series of large and notorious corporate frauds (most notably Enron, Tyco, WorldCom and Adelphi). For example, the cost of outside experts (accountants and attorneys) more than tripled from 1999 to 2007 as seen from form S-1 registration statements of technology companies as disclosed on the SEC's Edgar shown in FIG. 2.

The market for IPOs deteriorated markedly in the first half of 2008. However, even in the comparatively robust IPO market of 2005-2007, as shown in FIG. 3, the range of outcomes was high and the number of transactions that had negative outcomes (priced below the low end of the range or withdrawn) averaged over 40% across all industries.

Apparently, the U.S. equity capital market structure no longer supports equity capital formation the way it did prior to the internet, decimalization and Sarbanes-Oxley. Perpetual Revenue Participation Interests are likely to provide investors with a risk-mitigated (current cash pay) way to gain exposure to small capitalization companies and help bridge those companies to the stage of development where the issuer is large enough to be able to issue enough common stock to have a successful common stock offering capable of sustaining buy-side (investor) and sell-side (research) interest.

There are a series of applications for which Perpetual Revenue Participation Interests may be extremely well suited:

1) 144A Market—In the last decade, tradable “private” equity offerings have been made subject to a Regulation D safe harbor to accredited investors and QIBs (qualified institutional buyers). There have been a number of recent private marketplace entrants that have been established to serve this market including GSTrUE (Goldman Sachs Tradable Unregistered Equities), The NASDAQ Portal Alliance and Opus-5. 144A equity offerings trade in the aftermarket (after transaction pricing) under a rule “144A” safe harbor between similarly “qualified” investors. These offerings are exempt from registration with the SEC. One form, the so-called 144A “PIPO” or “Pre-IPO” is generally used as interim financing bridge to an IPO (issuers may be required to publicly list their shares within say 2 years or face a series of escalating penalties) or delayed public listing. There is interest in the 144A equity market being used as a permanent capital solution with no obligation to list publicly (Oak Tree Investments executed a $600 million equity offering through the GSTrUE market) but because of these instruments are marketed to a narrow universe of buyers, and the securities are not current cash pay, the market is extremely illiquid—market makers will avoid committing capital to these positions because they have no “dividend” or “yield” component from their security positions to cover their cost of capital. This is what is known as a “negative cost of carry” for market makers and creates a large disincentive for market makers to commit capital. A $200 million equity offering in this market will typically trade only 2 times per week (by contrast, a public equity of similar size may trade continuously on the NYSE, NASDAQ or AMEX stock markets). Perpetual Revenue Participation Interests have never been sold to multiple investors subject to a Regulation D or 144A safe harbor. This security, however, offers the growth of an equity, with current cash dividend or yield, that it will expand the 144A market by providing a less volatile growth instrument that can be leveraged (investors can borrow to purchase the instruments and better match assets and liabilities), thus also attracting market making by lowering the so-called “cost-to-carry” these security positions.

2) Direct Investment in a Company—Most private equity investments rely on a “liquidity put” so that the investor may realize a return. This “liquidity put” may take the form of a finite life to the instrument where principal must be repaid, or where the company must go public. Alternatively, in private companies, where there is no “liquidity put”, minority stakeholders may have no practical way to realize a return on their investment, even if the company does well. The Perpetual Revenue Participation Interest would provide investors a way to directly participate in the success of the company without requiring a “liquidity put” (forced sale of the company or principal repayment at maturity of the instrument). For these reasons, the perpetual private placement may find application in:

a. Direct Investments
i. By Venture capital
ii. By Private Equity
iii. By Angel Investors

b. ESOPs and Leveraged ESOPs

c. Private Markets & Public Markets
i. As tradable instruments or untradable instruments
ii. Can be pooled into
   1. Mutual Funds
   2. BDCs (Business development companies)
   3. LLCs
   4. LPs
   5. ETFs (exchange traded funds)

3) Alignment of Partner Interests—Law firms, accounting firms and other partnerships might be able to raise capital from their partners (or “members” as is the case with LLCs) by providing partners with Perpetual Revenue Participation Interests in lieu of cash compensation, or allowing partners and/or outside investors to purchase these instruments. Partnerships that own these instruments would then have an even greater incentive to drive the revenue growth of the business to improve the value of the revenue participation interests that they now hold.

4) Recapitalization/Exit for Inside Shareholders—Equity (common stock) interests in private companies can be illiquid and extremely tough to value. It should be possible for a company to issue its own Perpetual Revenue Participation Interests in exchange for common stock held by investors (be they founders, insiders, venture capitalists or private equity firms) in a manner which is anti-dilutive to the common shareholders (increases earnings or EBITDA) attributable to common, and provides the holder with a current cash pay (or accrual) instrument that is directly (through cash received) or indirectly (through sale to other investors) more liquid. The value of a Perpetual Revenue Participation Interest will be easier to establish because the value will be based on an assessment of the potential for company revenue growth—as opposed to common stock valuations that rely on company earnings or EBITDA estimates. Alternatively, a company could issue a Perpetual Revenue Participation Interest for cash and use the proceeds to redeem (purchase and retire) common stock that is outstanding in a manner that is anti-dilutive to the remaining common shareholders.

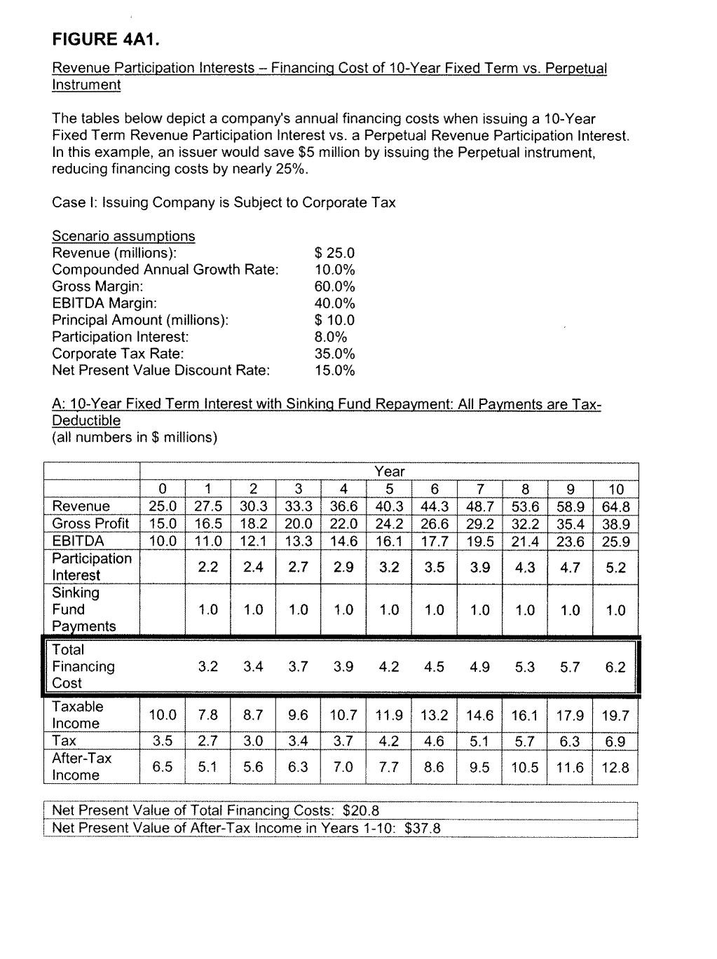

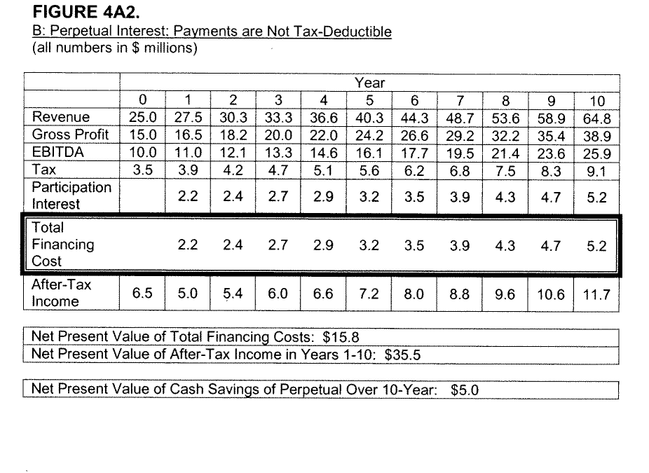

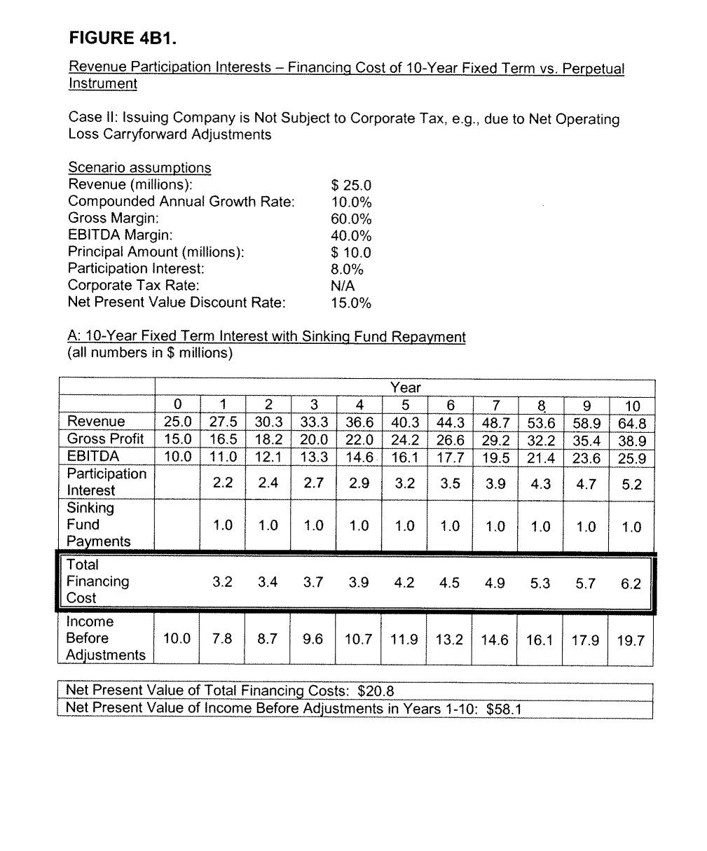

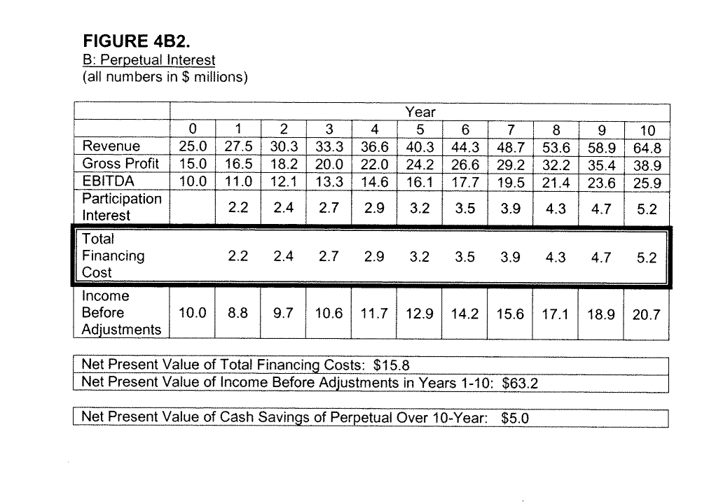

An exemplary result comparison of a Perpetual Revenue Participation Interest that exists in perpetuity with a Revenue Sales Participation Interest that exists for a specified period of time is shown in FIGS. 4A1, 4A2, 4B1, and 4B2.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. A method for creating a financial product comprising: providing terms to an issuer and to investors, the terms to the issuer including providing capital to the issuer in exchange for a return that is a function of future sales or revenues in perpetuity, the terms to the investors being the receipt of a return in perpetuity based on the issuer's future sales or revenues, the capital provided to the issuer being provided by investors investing in the financial product; and arranging for the creation of instruments representing investment in the financial product.

2. A financial product created by the method of claim 1.

3. A computer-implemented method for creating a financial product comprising conducting one or more of the following steps with a computer system:
a. providing terms to an issuer and to investors, the terms to the issuer including providing capital to the issuer in exchange for a return that is a function of future sales or revenues in perpetuity, the terms to the investors being the receipt of a return in perpetuity based on the issuer's future sales or revenues, the capital provided to the issuer being provided by investors investing in the financial product; and
b. creating instruments representing investment in the financial product.
